(19) United States
(12) Patent Application Publication
(10) Pub. No.: US 2026/0140323 A1
(43) Pub. Date: May 21, 2026

(54) 2D COLLIMATOR ARRAY WITH REDUCED BACK REFLECTION

(71) Applicant: II-VI Delaware, Inc., Wilmington, DE (US)

(72) Inventors: Haijun Yuan, Wilmington, DE (US); Xinping Shi, Wilmington, DE (US); Lixin (Lawrence) Wang, Wilmington, DE (US); Qingyu Li, Wilmington, DE (US)

(21) Appl. No.: 19/350,711

(22) Filed: Oct. 6, 2025

Related U.S. Application Data
(60) Provisional application No. 63/706,102, filed on Oct. 11, 2024.

(51) Int. Cl. G02B 6/32; G02B 1/11

(52) U.S. Cl. CPC G02B 6/327; G02B 1/11

(57) ABSTRACT

This disclosure describes a system and method for providing a 2D collimator array with reduced back reflection. The collimator array comprises a pair of angled glass plates between a lens array and a fiber array. The lens array and the fiber array each comprise a plurality of angled holes.

### CROSS REFERENCE TO RELATED APPLICATIONS

This application claims priority to and the benefit of U.S. Provisional Patent Application No. 63/706,102 entitled “2D COLLIMATOR ARRAY WITH REDUCED BACK REFLECTION” filed Oct. 11, 2024, which is hereby incorporated herein by reference in its entirety.

### BACKGROUND

Limitations and disadvantages of a traditional collimator arrays will become apparent to one of skill in the art, through comparison of such approaches with some aspects of the present method and system set forth in the remainder of this disclosure with reference to the drawings.

### BRIEF SUMMARY

Systems and methods provide a 2D collimator array with reduced back reflection, substantially as illustrated by and/or described in connection with at least one of the figures, as set forth more completely in the claims.

### BRIEF DESCRIPTION OF THE DRAWINGS

FIG. 1 illustrates an example structure of a 2D collimator array with a lens array and a fiber array with angled holes, in accordance with various example implementations of this disclosure.

FIG. 2 illustrates an example matrix grid for the fiber array and the lens array, in accordance with various example implementations of this disclosure.

FIGS. 3A, 3B and 3C illustrate an example 2D collimator array comprising a flat fiber array and a flat lens array, in accordance with various example implementations of this disclosure.

FIGS. 4A, 4B and 4C illustrate an example 2D collimator array, without compensation, comprising an angled fiber array and an angled lens array, in accordance with various example implementations of this disclosure.

FIGS. 5A, 5B and 5C illustrate an example 2D collimator array, with compensation, comprising an angled fiber array and an angled lens array, in accordance with various example implementations of this disclosure.

FIG. 6 illustrates an example ray tracing comparison of three collimator arrays, in accordance with various example implementations of this disclosure.

### DETAILED DESCRIPTION

The figures illustrate a general manner of construction. Descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denotes the same elements.

The term “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

Also, any numerical range recited herein is intended to include all sub-ranges subsumed therein. For example, a range of “1 to 10” is intended to include any and all sub-ranges between and including the recited minimum value of 1 and the recited maximum value of 10, that is, all sub-ranges beginning with a minimum value equal to or greater than 1 and ending with a maximum value equal to or less than 10, and all sub-ranges in-between, e.g., 1 to 6.3, or 5.5 to 10, or 2.7 to 6.1.

For a single collimator or a 1D collimator array, the fiber end-face may be angled relative to the surface of the lens to reduce back reflection. However, this approach is not feasible for 2D arrays, as the surfaces of the fiber array and the lens array must be parallel for proper alignment.

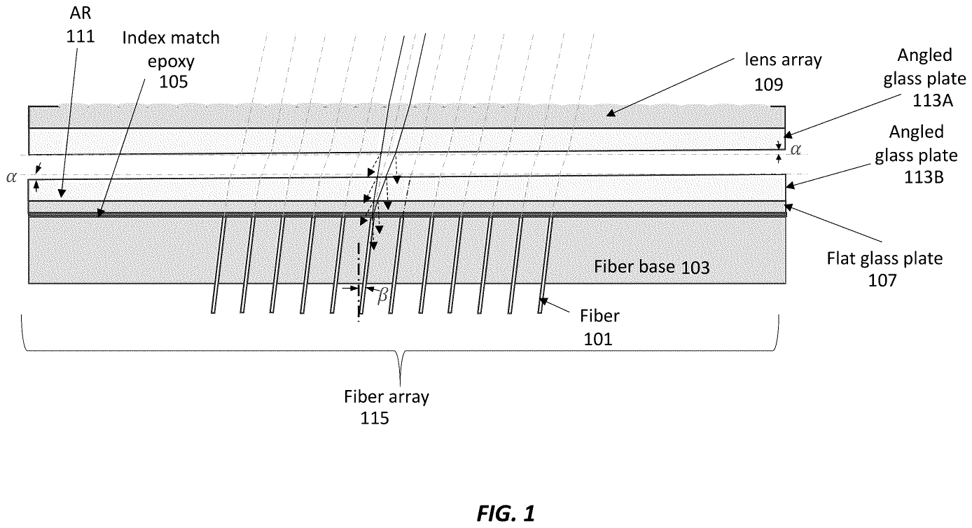

FIG. 1 illustrates an example structure of a 2D collimator array with a lens array 109 and a fiber array 115, in accordance with various example implementations of this disclosure. The lens array 109 and the fiber array 115 each comprise a plurality of angled holes.

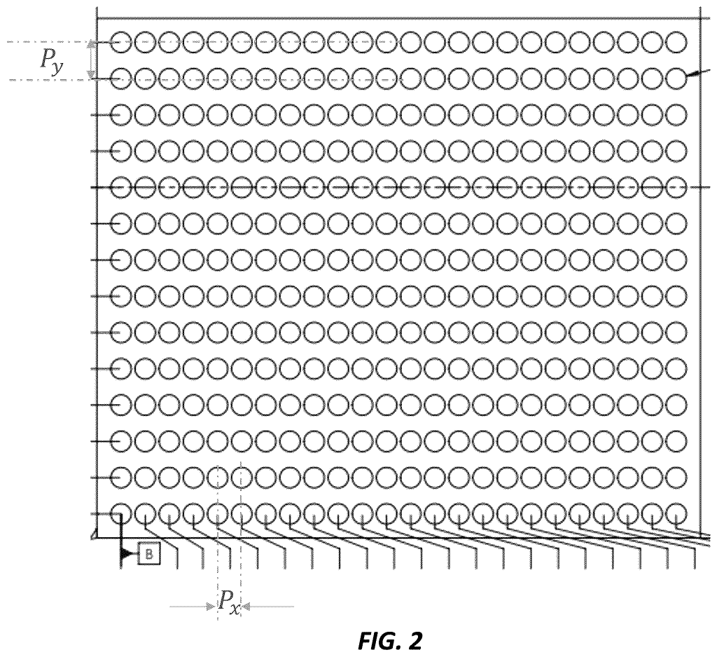

The fiber array 115 comprises fibers 101 and a fiber base plate 103. The fiber base plate 103 comprises holes that allow fiber 101 to feed through. The hole centers of the fiber base plate 103 match a designed matrix grid, an example of which is shown in FIG. 2. The center axis of the through hole has an angle (□) to the surface normal axis of the fiber base plate 103. The angle (□) is configured to reduce the reflection from a fiber end being coupled back to a fiber core.

The fibers 101 are configured with propagation modes. A single mode may allow beam propagation in the core of a fiber 101 with low loss. Each fiber 101 may be fed through an individual hole and may be bonded with the hole by epoxy. The end of fiber 101 may be polished with the base plate 103 surface. A beam that comes out at the end of fiber 101 may be diverse.

A flat glass plate 107 may be designed with a certain thickness and may comprise antireflection (AR) coating 111 on the first side to avoid reflection coupling back to the fiber core. The flat glass plate 107 may have a refractive index that is very close to the refractive index of the fiber 101 core. The first side of flat glass plate 107 may be coated with the AR 111 to decrease reflections in the range of the operational wavelength.

A second side of the flat glass plate 107, without AR, may be bonded to the fiber array 115 with epoxy 105 that may have a refractive index that is close to the refractive index of the fiber 101 core and the glass plate 107. The thickness of the glass plate 107 may be configured to further reduce the reflection from the AR 111 surface being coupled back into the fiber core.

The lens array 109 may be configured and positioned in a way to provide collimated beams. Each lens of the lens array 109 may be identical and have the same focal length, f. The refractive index of lens array 109 may be selected as large as possible to allow a relatively flat curvature of lens for a certain focal length. The focal length may be configured according to the required properties of the output collimated beam such as the beam waist and the working distance.

The lens array 109 may be placed at a certain distance from, and in parallel to, the fiber array 115. The distance may be configured according to the requirement of collimation. The center of each lens is aligned to the center of the beam which comes from a corresponding fiber 101 core of the fiber array 115.

If the beam comes from the angled end of the fiber 101 core without compensation, the principal axis of the beam may not be perpendicular to the corresponding lens of the lens array 109. This may introduce a large distortion to the beam after the beam passes through the lens array 109. To compensate for this distortion, angled glass plates 113A and 113B are introduced.

The chamfered angle (a) may be configured according to the distortion caused by the fiber end angle (□) and the lens curvature. This may avoid back reflections from being coupled into fiber 101 core.

The angled glass plates 113A and 113B each have the same chamfered angle (□) and thickness. As illustrated in FIG. 1, the angled glass plates 113A and 113B are positioned such that the thicker side of angled glass plate 113A is proximate to the thinner side of angled glass plate 113B and the thicker side of angled glass plate 113B is proximate to the thinner side of angled glass plate 113A. The angled glass plates 113A and 113B each have the same refractive index as that of the lens array 109.

The angled glass plates 113A and 113B may be referred to as a pair of wedges. In addition to compensating for the distortion, the angled glass plates 113A and 113B may also keep all lenses in focus to the fiber tips. In addition, the angled glass plates 113A and 113B may be used for fine adjustment of an optical length between a fiber end and the lens lets by sliding each of the angled glass plates 113A and 113B in opposite directions.

The current disclosure employs an angled end-face on the fiber array 115 while maintaining the lens array 109 surface parallel to it. Although this reduces back reflection, the angle may introduce beam distortion and additional insertion loss. To address this issue, a pair of glass wedges is introduced between the fiber array 115 and the lens array 109. This setup reduces beam distortion and enhances coupling efficiency. A back reflection of −45 dB or less may be achieved with minimal impact on insertion loss.

FIG. 2 illustrates an example matrix grid for the fiber array 115 and the lens array 109 of FIG. 1, in accordance with various example implementations of this disclosure.

The fiber array and the lens array may have the same matrix grid with the same pitches of Px and Py respectively to x, y dimensions. The hole centers of the fiber array and the lens array may match the designed matrix grid of FIG. 2.

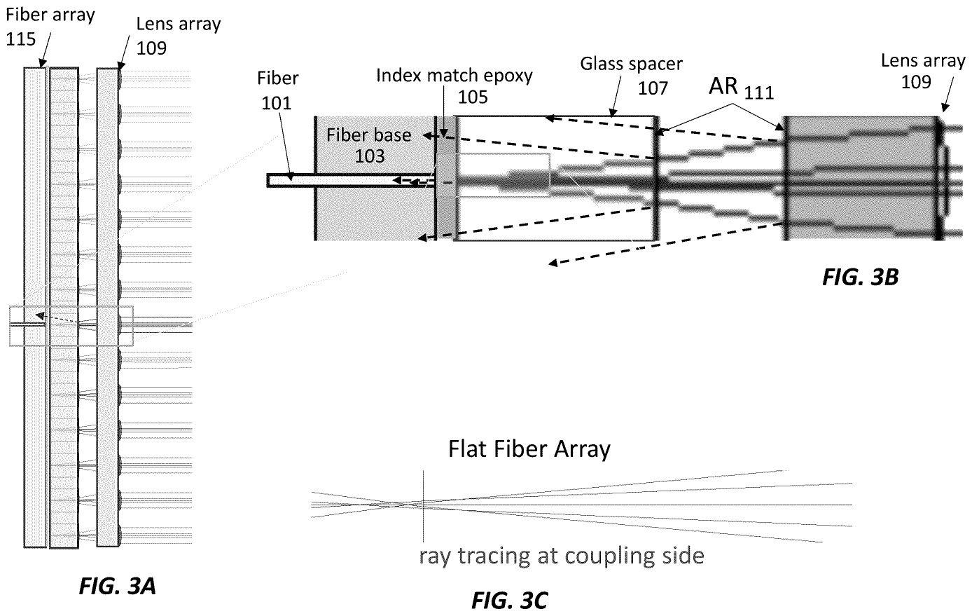

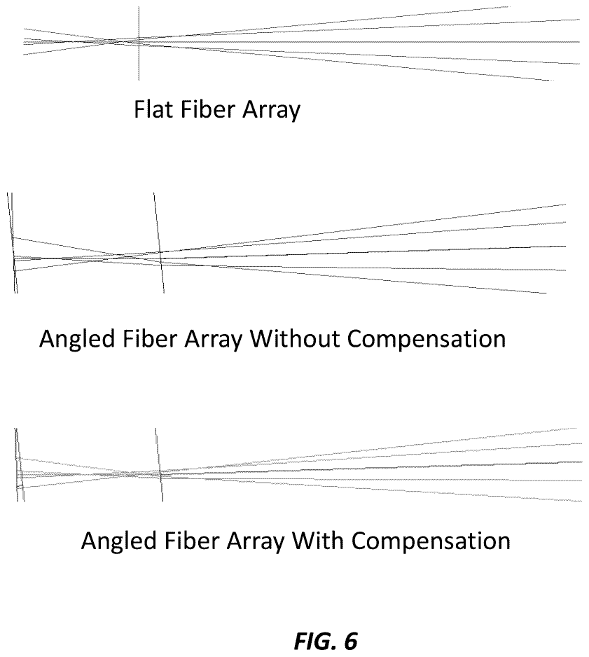

FIG. 3A illustrates an example 2D collimator array comprising a flat fiber array 115 and a flat lens array 109, in accordance with various example implementations of this disclosure. FIG. 3B illustrates an enlarged view of the interface between a fiber 101 and a lens of the lens array 109. FIG. 3C illustrates a ray tracing at the coupling side. The dashed arrows correspond to example spurious beams/rays. A comparison to the spurious beam reduction via the disclosed design is illustrated below with respect to FIG. 6.

The flat fiber end, with index match epoxy 105, may result in a return loss of up to −38 dB.

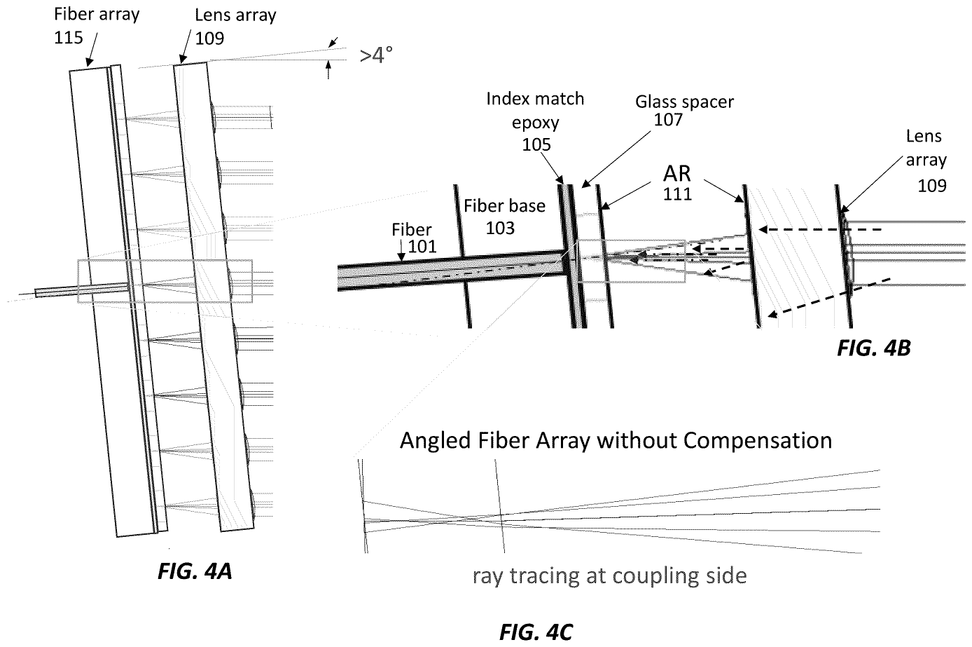

FIG. 4A illustrates an example 2D collimator array, without compensation, comprising an angled fiber array and an angled lens array, in accordance with various example implementations of this disclosure. FIG. 4B illustrates an enlarged view of the interface between a fiber 101 and a lens of the lens array 109. FIG. 4C illustrates a ray tracing at the coupling side. The dashed arrows correspond to example spurious beams/rays. A comparison to the spurious beam reduction via the disclosed design is illustrated below with respect to FIG. 6.

With an angle (e.g., >4°), the angled fiber end, with index match epoxy 105, may improve the return loss (e.g., <−45 dB).

However, the angle (e.g., >4°) may result in the beam passing the lens array 109 with a large angle that causes collimated beam distortion and leads to an extra insertion loss in the coupling of paired collimator arrays.

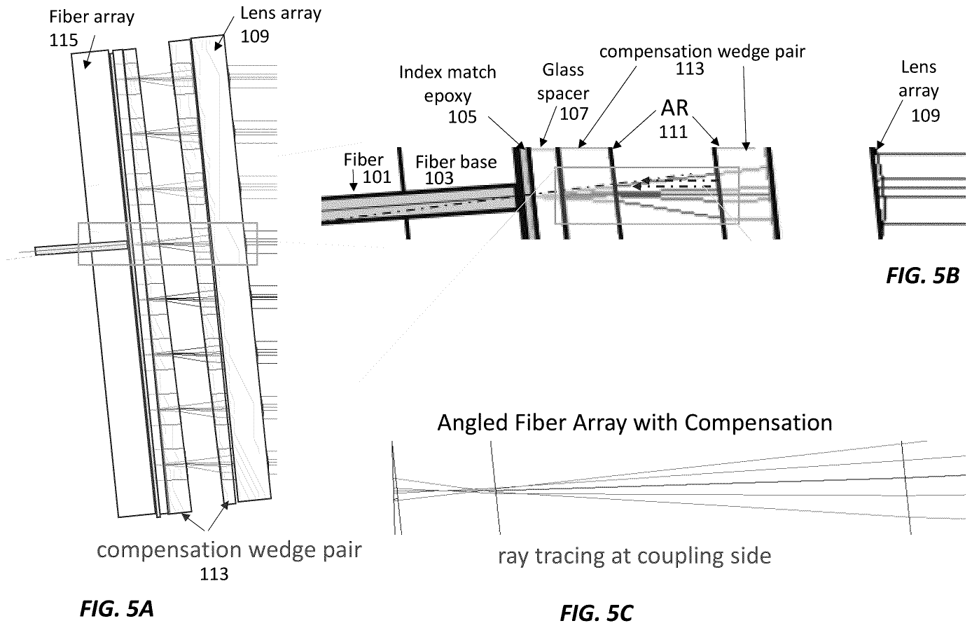

FIG. 5A illustrates an example 2D collimator array, with compensation, comprising an angled fiber array and an angled lens array, in accordance with various example implementations of this disclosure. FIG. 5B illustrates an enlarged view of the interface between a fiber 101 and a lens of the lens array 109. FIG. 5C illustrates a ray tracing at the coupling side. The dashed arrows correspond to example beams/rays in the disclosed design.

The example 2D collimator array in FIGS. 5A, 5B and 5C is like the 2D collimator array described above regarding FIG. 1.

FIG. 6 illustrates an example ray tracing comparison of three collimator arrays in FIGS. 3A, 4A and 5A, in accordance with various example implementations of this disclosure. The ray tracing comparison of FIG. 6 places FIGS. 3C, 4C and 5C side-by-side to illustrate the relative improvement of coupling efficiency.

The disclosed 2D collimator array comprises a grid of optical fibers and lenses. The grid of optical fibers is operably coupled to a fiber plate with angled holes so light leaving the fiber does not bounce straight back into the fiber core. This helps cut down reflection. However, the angled hole also bends a beam and causes distortion.

To fix that, this design adds two glass wedges between the fiber plate and a lens plate. These wedges cancel out the beam distortion, keep the lenses in focus, and may be adjusted to fine-tune the optical path length. This results in low back reflection (better than −45 dB) with minimal added loss, which is better than conventional 2D collimator designs.

The 2D collimator array system comprises a fiber array, a lens array and a pair of angled glass plates. The fiber array comprises a plurality of holes. Each hole of the plurality of holes is configured to receive an optical fiber, and each hole of the plurality of holes is angled relative to a normal of the fiber array to reduce back reflection. The lens array is positioned parallel to the fiber array, and the lens array comprises a plurality of lenses aligned with the plurality of holes. The pair of angled glass plates is disposed between the fiber array and the lens array, and the angled glass plates are configured to compensate for beam distortion caused by the plurality of holes of the fiber array.

In some embodiments, the pair of angled glass plates comprises a pair of wedges having equal chamfer angles and thicknesses. In some embodiments, the pair of wedges are arranged with an opposite orientation to one another.

In some embodiments, the fiber array comprises a fiber base plate with through-holes. In some embodiments, the through-holes are bonded to the fibers using index-matching epoxy.

In some embodiments, at least one glass plate comprises an antireflection coating. In some embodiments, the pair of angled glass plates are slidable relative to one another to fine-adjust an optical path length. In some embodiments, the 2D collimator array system provides a back reflection of less than −45 dB.

In some embodiments, the lens array comprises a refractive index selected to flatten lens curvature for a given focal length.

The disclosed method of reducing back reflection in a 2D collimator array comprises providing a fiber array with angled holes to reduce reflection back into fiber cores, aligning a lens array in parallel with the fiber array, disposing a pair of angled glass wedges between the fiber array and the lens array, and compensating for beam distortion introduced by the angled fiber ends using the pair of angled glass wedges.

In some embodiments of the method, the pair of angled glass plates comprises a pair of wedges having equal chamfer angles and thicknesses. In some embodiments of the method, the pair of wedges are arranged with an opposite orientation to one another.

In some embodiments of the method, the fiber array comprises a fiber base plate with through-holes. In some embodiments of the method, the through-holes are bonded to the fibers using index-matching epoxy.

In some embodiments of the method, at least one glass plate comprises an antireflection coating. In some embodiments of the method, the pair of angled glass plates are slidable relative to one another to fine-adjust an optical path length. In some embodiments of the method, the 2D collimator array system provides a back reflection of less than −45 dB.

In some embodiments of the method, the lens array comprises a refractive index selected to flatten lens curvature for a given focal length.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system are not limited to the implementations disclosed, but that the present method and/or system will include all implementations falling within the scope of the appended claims.

What is claimed is:

1. A 2D collimator array system, comprising:
a fiber array comprising a plurality of holes, wherein each hole of the plurality of holes is:
configured to receive an optical fiber, and
angled relative to a normal of the fiber array to reduce back reflection;
a lens array positioned parallel to the fiber array, wherein the lens array comprises a plurality of lenses aligned with the plurality of holes; and
a pair of angled glass plates disposed between the fiber array and the lens array, wherein the angled glass plates are configured to compensate for beam distortion caused by the plurality of holes of the fiber array.

2. The system of claim 1, wherein:
the pair of angled glass plates comprises a pair of wedges having equal chamfer angles and thicknesses, and
the pair of wedges are arranged with an opposite orientation to one another.

3. The system of claim 1, wherein:
the fiber array comprises a fiber base plate with through-holes, and
the through-holes are bonded to the fibers using index-matching epoxy.

4. The system of claim 1, wherein at least one glass plate comprises an antireflection coating.

5. The system of claim 1, wherein the pair of angled glass plates are slidable relative to one another to fine-adjust an optical path length.

6. The system of claim 1, wherein the system provides a back reflection of less than −45 dB.

7. The system of claim 1, wherein the lens array comprises a refractive index selected to flatten lens curvature for a given focal length.

8. A method of reducing back reflection in a 2D collimator array, comprising:
providing a fiber array with angled holes to reduce reflection back into fiber cores;
aligning a lens array in parallel with the fiber array;
disposing a pair of angled glass wedges between the fiber array and the lens array; and
compensating for beam distortion introduced by the angled fiber ends using the pair of angled glass wedges.

9. The method of claim 8, wherein:
each angled glass wedge comprises a chamfer angle and a thickness that are equal to those of the other angled glass wedge, and
the pair of angled glass wedges are arranged with an opposite orientation to one another.

10. The method of claim 8, wherein:
the fiber array comprises a fiber base plate with through-holes, and
the through-holes are bonded to the fibers using index-matching epoxy.

11. The method of claim 8, wherein at least one glass plate comprises an antireflection coating.

12. The method of claim 8, wherein the pair of angled glass wedges are slidable relative to one another to fine-adjust an optical path length.

13. The method of claim 8, wherein the system provides a back reflection of less than −45 dB.

14. The method of claim 8, wherein the lens array comprises a refractive index selected to flatten lens curvature for a given focal length.
